(19) United States
(12) Patent Application Publication
(10) Pub. No.: US 2015/0244645 A1
(43) Pub. Date: Aug. 27, 2015

(54) INTELLIGENT INFRASTRUCTURE CAPACITY MANAGEMENT

(71) Applicants: Jonathan LINDO, Santa Clara, CA (US); Vamsee LAKAMSANI, Livermore, CA (US); Vikas KRISHNA, San Jose, CA (US); Nagi PRABHU, Saratoga, CA (US)

(72) Inventors: Jonathan LINDO, Santa Clara, CA (US); Vamsee LAKAMSANI, Livermore, CA (US); Vikas KRISHNA, San Jose, CA (US); Nagi PRABHU, Saratoga, CA (US)

(73) Assignee: CA, INC., Islandia, NY (US)

(21) Appl. No.: 14/267,181

(22) Filed: May 1, 2014

Related U.S. Application Data
(60) Provisional application No. 61/944,986, filed on Feb. 26, 2014.

(51) Int. Cl. H04L 12/911; G06N 5/04; H04L 12/26

(52) U.S. Cl. CPC H04L 47/823; H04L 43/0876; G06N 5/04

(57) ABSTRACT

Systems and methods may include receiving first data regarding first devices in a network. The first data may include an amount of utilization of first resources in the network by each device of the first devices. The first data also may include characteristic data of each device of the first devices. Systems and methods may include determining a predictive model for utilization of each resource of second resources in the network based on the first data. Systems and methods may include predicting an amount of utilization of each resource of the second resources by second devices using the predictive model. Systems and methods may include allocating each resource of the second resources based on the predicted amount of utilization of such resource by the second devices.

### CROSS-REFERENCE TO RELATED APPLICATION

This application claims the benefit of U.S. Provisional Application No. 61/944,986, filed Feb. 26, 2014, the disclosure of which is incorporated herein by reference.

### BACKGROUND

The present disclosure relates to infrastructure management and, more specifically, to a system and method for intelligent infrastructure capacity management.

With the explosion of mobile computing devices, the amount of global computing power has grown exponentially, and this trend is continuing to expand at an ever-increasing pace due to the growth of internet connected devices, smart sensors, wearable computers, and the internet of things.

### BRIEF SUMMARY

According to an aspect of the present disclosure, a method may include receiving first data regarding a first plurality of devices in a network. The first data may include an amount of utilization of a first plurality of resources in the network by each device of the first plurality of devices. The first data also may include characteristic data of each device of the first plurality of devices. The method may include determining a predictive model for utilization of each resource of a second plurality of resources in the network based on the first data. The method may include predicting an amount of utilization of each resource of the second plurality of resources by a second plurality of devices using the predictive model. The method may include allocating each resource of the second plurality of resources based on the predicted amount of utilization of such resource by the second plurality of devices.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 is a schematic representation of a network 1 on which systems and methods for intelligent infrastructure capacity management may be implemented.

FIG. 2 is a schematic representation of a system configured to provide intelligent infrastructure capacity management based on resource usage patterns.

FIG. 3 illustrates an intelligent infrastructure capacity management process.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to resource and infrastructure management, and more specifically to intelligent resource and infrastructure management, as related to IT service and asset management in cloud computing, systems and methods disclosed herein may be related to other areas beyond cloud computing. Systems and methods disclosed herein may be applicable to a broad range of applications that require access to network resources and infrastructure and that are associated with various disciplines, such as, for example, research activities (e.g., research and design, development, collaboration), commercial activities (e.g., sales, advertising, financial evaluation and modeling, inventory control), IT systems (e.g., computing systems, cloud computing, network access, security, service provisioning), and other activities of importance to a user or organization.

With the explosion of mobile computing devices, the amount of global computing power has grown exponentially, and this trend is continuing to expand at an ever-increasing pace due to the growth of internet connected devices, smart sensors, wearable computers and the internet of things. All of this has created an enormous surge in server and infrastructure requirements to meet the new demands of these new devices. A simple example of this exponential growth is captured in the number of times the average worker checked email in a 24 hour period. In 2007, this number was 10-15, but in 2013, it is closer to 200-300 per day. In addition, these new demands are often unpredictable due to the distributed nature of these devices both from physical and IP network standpoints. Cellular networks such as EDGE, 3G, 4G, and LTE, as well as Wifi, all provide a plethora of origins for infrastructure load.

Systems and methods disclosed herein may provide a mechanism for intelligent infrastructure capacity management. Specifically, through the collection and analysis of real-time usage data informed by location, network, behavior, and trends, systems and methods disclosed herein may predict and proactively manage surges, peaks, and valleys in infrastructure load. For example, server load and capacity requirements may be predicted based on mobile app download, usage, and geo-location.

Instrumentation disclosed herein may be applied to any mobile application and may enable the capture of the complete end-user experience including both input and output to and from any mobile app. Moreover, instrumentation disclosed herein may be applied to any mobile application and may further enable the capture of relevant data to inform a predictive analytics engine for the purposes of capacity planning and real-time server load management. By monitoring metrics and data collected from mobile apps, such as number of downloads, frequency and duration of mobile app sessions, location of devices, number of network requests made from mobile apps, and amount of data sent/received by mobile apps, the capacity requirements of the servers, network, and databases may be predicted proactively, and actual capacity may be adjusted to meet short-term future demand via automation in a cloud-based elastic computing environment.

As an example, it may be known that users who have installed and run an application X are likely to also install and run an application Y. Understanding that users with mobile devices who have installed application X are located with a high concentration in a particular geo-location would therefore allow for the proactive provisioning of infrastructure capacity for application Y in the aforementioned geo-location.

Furthermore, static data and content required by mobile apps may also proactively be pushed out into carriers caching servers and content delivery networks (CDNs) based on observed real-time app usage and geo-location.

In certain configurations, server load and capacity requirements may be predicted based on mobile app download, usage, and geo-location. By monitoring metrics and data collected from mobile apps, such as number of downloads, frequency and duration of mobile app sessions, location of devices, number of network requests made from mobile apps, and amount of data sent/received by mobile apps, the capacity requirements of the servers, network and databases may be predicted proactively and actual capacity can be adjusted to meet short-term future demand via automation in a cloud-based elastic computing environment. Instrumentation may be applied to any mobile application enabling the capture of relevant data to inform a predictive analytics engine for the purposes of capacity planning and real-time management. Static data and content required by mobile apps can also proactively be pushed out into carriers caching servers and content delivery networks based on observed app usage and geo-location.

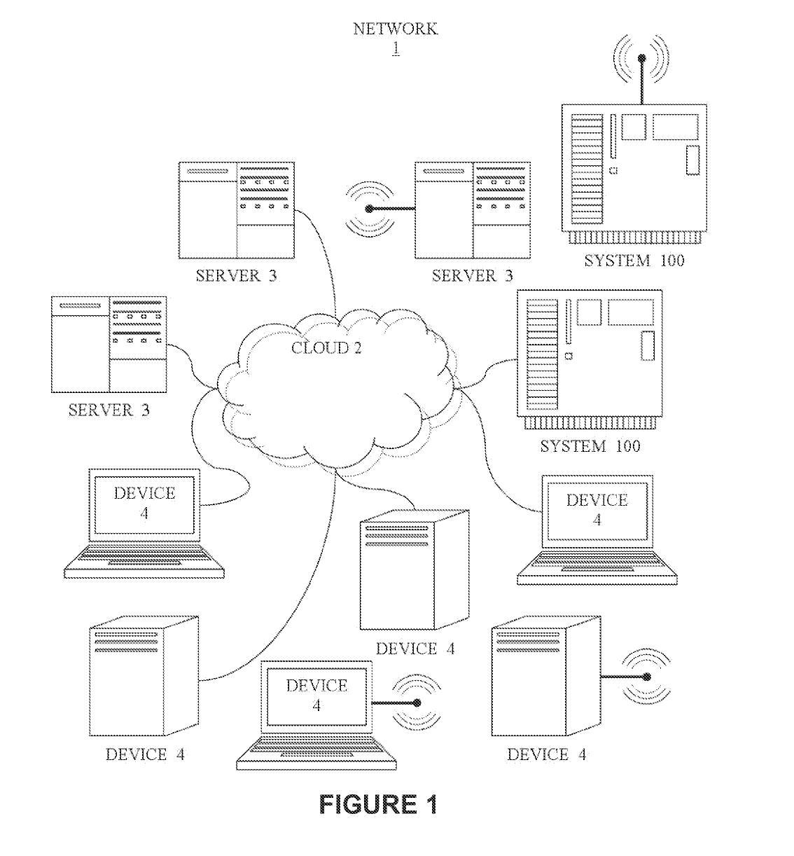

Referring now to FIG. 1, a network 1 comprising a plurality of resources now is disclosed. Systems and methods for intelligent infrastructure capacity management may be implemented on network 1. Network 1 may comprise one or more clouds 2, which may be public clouds, private clouds, or community clouds. Each cloud 2 may permit the exchange of information, services, and other resources between various identities that are connected to such clouds 2. In certain configurations, cloud 2 may be a wide area network, such as the Internet. In some configurations, cloud 2 may be a local area network, such as an intranet. Further, cloud 2 may be a closed, private network in certain configurations, and cloud 2 may be an open network in other configurations. Cloud 2 may facilitate wired or wireless communications between identities and may permit identities to access various resources of network 1.

Network 1 may comprise one or more servers 3 that may at least store resources thereon, host resources thereon, or otherwise make resources available. Such resources may comprise, but are not limited to, information technology services, financial services, business services, access services, other resource-provisioning services, secured files and information, unsecured files and information, accounts, and other resources desired by one or more entities. More generally, servers 3 may comprise, for example, one or more of general purpose computing devices, specialized computing devices, mainframe devices, wired devices, wireless devices, and other devices configured to provide resources to consumers.

Referring now to FIG. 1, a network 1 for service providers and consumers of provided services now is described. Network 1 may comprise one or more clouds 2, which may be public clouds, private clouds, or community clouds. Each cloud 2 may permit the exchange of information and services between information providers, service providers, consumers of provided information, consumers of provided services, and brokers that are connected to such clouds 2. In certain configurations, cloud 2 may be a wide area network, such as the Internet. In some configurations, cloud 2 may be a local area network, such as an intranet. Further, cloud 2 may be a closed, private network in certain configurations, and cloud 2 may be an open network in other configurations. Cloud 2 may facilitate wired or wireless communications between information providers, service providers, consumers of provided information, consumers of provided services, and brokers.

Network 1 may comprise one or more servers 3 and other devices operated by one or more service providers. Network 1 also may comprise one or more devices 4 utilized by one or more consumers of provided services. The one or more service providers may provide services to the one or more consumers utilizing the one or more servers 3, which connect to the one or more devices 4 via cloud 2. The services may comprise, for example, information technology services, financial services, business services, access services, and other resource-provisioning services. Servers 3 may comprise, for example, one or more of general purpose computing devices, specialized computing devices, mainframe devices, wired devices, wireless devices, and other devices configured to provide services to consumers. Devices 4 may comprise, for example, one or more of general purpose computing devices, specialized computing devices, mobile devices, wired devices, wireless devices, passive devices, routers, switches, and other devices utilized by consumers of provided services.

Moreover, network 1 may comprise one or more system 100 that may monitor and collect data regarding the usage of infrastructure in network 1 (e.g., the utilization and provisioning of resources), may analyze such data and develop and/or refine predictive models regarding the usage of infrastructure in network 1, may apply such predictive models to the collected data, and may proactively allocate resources within network 1 to intelligently manage network capacity. System 100 may be, for example, one or more of a general purpose computing device, a specialized computing device, a wired device, a wireless device, and any other device configured to proactively optimize services provided by the one or more service providers to the one or more consumers. System 100 may connect to cloud 2 and monitor servers 3 and the services available from the one or more service providers. System 100 also may monitor devices 4 and the services provided to the one or more consumers of provided services via cloud 2. By monitoring the one or more service providers and the one or more consumers, system 100 may generate rich datasets regarding available services and consumption patterns, comprising lists of available services, quality information about the available services, and consumer preferences for certain services. System 100 may utilize these data sets to determine correlations in resource utilization and to intelligently build predictive models for future utilization based on present behavior. In this manner, system 100 may proactively allocate network resources based on current resource usage and predicted future utilization.

In some configurations, one or more of a server 3 operated by a service provider and a device 4 operated by a consumer may comprise system 100. In other configurations, system 100 may be separate from servers 3 and devices 4. In certain configurations, system 100 may be operated by a party other than a service provider or a consumer of provided services.

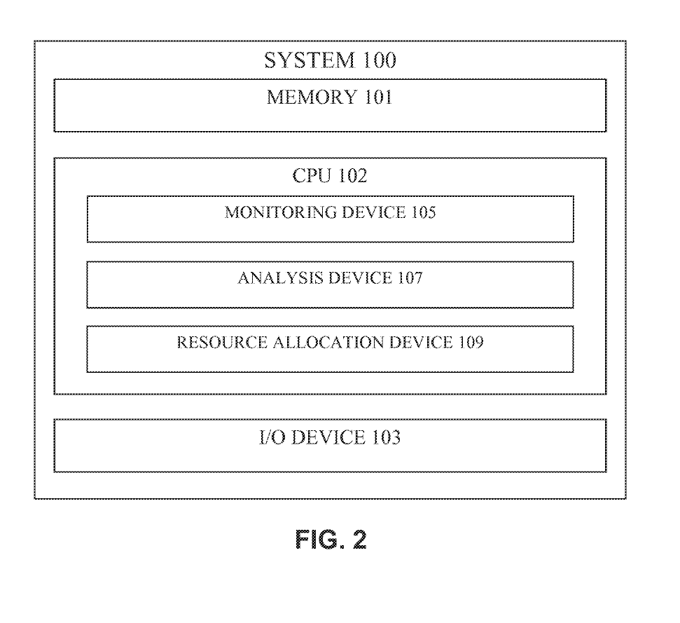

Referring now to FIG. 2, system 100, configured to provide intelligent infrastructure capacity management based on resource usage patterns, now is described. System 100 may comprise a memory 101, a CPU 102, and an input and output (“I/O”) device 103. Memory 101 may store computer-readable instructions that may instruct system 100 to perform certain processes. In particular, when executed by CPU 102, the computer-readable instructions stored in memory 101 may instruct CPU 102 to operate as one or more of a monitoring device 105, and analysis device 107, and a resource allocation device 109. I/O device 103 may transmit data to/from cloud 2 and may transmit data to/from other devices connected to system 100. Further, I/O device 103 may implement one or more of wireless and wired communication between system 100 and other devices.

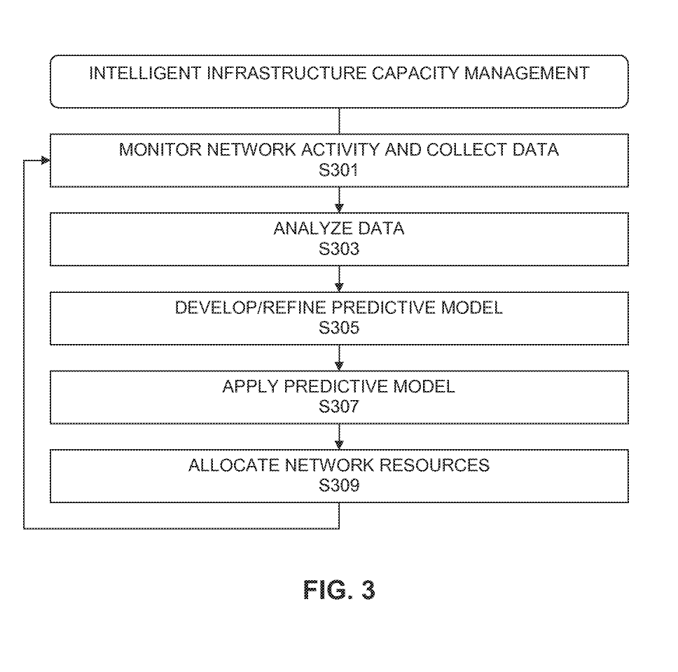

Referring now to FIG. 3, an intelligent infrastructure capacity management process now is described. In S301, monitoring device 105 may monitor activity on network 1 and may collect data related to such network activity. In particular, monitoring device 105 may monitor the utilization of resources throughout network 1. Monitoring device 105 may collect real-time usage data of resources informed by location, network, behavior, and trends of both the devices accessing the resources (e.g., devices 4) and the resources themselves (e.g., nodes within network 1, such as servers, ports, switches, routers, access points, communications towers and antenna relays, and other devices that form the infrastructure of network 1). Monitoring device 105 may collect data, such as, for example, the types of devices used to access resources, the numbers and identities or types of applications on such devices, the time of day that the devices are used, the types of data transmitted/received (e.g., video, voice, text, e-mail), the amount of data transmitted/received by such devices, the locations where data is transmitted/received, and what application was used to transmit/receive data, which may allow monitoring device 105 to create rich data sets regarding resource utilization within network 1. In certain configurations, such data may be referred to as characteristic data of the devices 4. For example, monitoring device 100 may collect a data point indicating that a particular type of mobile device (e.g., an iPhone, a device with a high-definition display, a device configured to utilize a 4G network) with a particular application installed (e.g., the Hulu app) uses significant network bandwidth to stream data. Nevertheless, other identifying data points may be collected, and it may not be necessary to collect data identifying a particular type or make of device in some configurations.

In S303, analysis device 107 may analyze the data sets collected in S301 to determine statistical correlations within the data. Consequently, analysis device 107 may determine strong correlations between certain types of mobile devices with certain applications installed and particular network usage patterns. For example, analysis device 107 may determine that there is a high correlation between having an iPhone with the Hulu app installed and high bandwidth usage. In a contrasting example, analysis device 107 may determine that there is a high correlation between having an iPhone with a small number of applications installed and low bandwidth usage. Analysis device 107 may search the collected data to determine significant correlations.

In S305, analysis device 107 may act as a predictive analytics engine to develop and or refine predictive models based on the correlations among the data points determined in S303. In particular, analysis device 107 may utilize the identified correlations between data points to predict future behavior based on the current characteristics of a device within network 1. For example, analysis device 107 may develop a model that predicts that an iPhone with the Hulu app installed will use a significant amount of bandwidth and, thus, will significantly burden the network resources when nearby. As more and more data is collected and S303 is repeated, analysis device 107 may further refine the predictive models developed in S305, and the accuracy of such models may improve significantly over time. Further, because data may be collected and analyzed in real-time, the predictive model may be extremely robust and may adapt with changing trends in network usage. In certain configurations, the predictive model may output an estimated utilization of a resource by a device in response to receiving as an input the characteristic data of such device and data identifying such resource.

In S307, analysis device 107 may apply the predictive models developed and/or refined in S305 to newly collected data to predict future network usage. For example, the newly collected data may indicate that a large number of iPhones with the Hulu app installed thereon are located within the region of a particular access point. Accordingly, by applying the predictive model that indicates that each such device will use a large amount of bandwidth, analysis device 107 may determine that this large number of iPhones with the Hulu app installed thereon will likely strain the capacity of the particular access point. For example, the newly collected data also may indicate that the region of a neighboring access point is largely iPhone free and only includes a few basic phones. Thus, applying the predictive model to this region may indicate that the lack of iPhones and the limited number of basic phones in this region will likely utilize only a minor portion of the capacity of the neighboring access point. The predicted amount of utilization of a resource may be a total estimated utilization of such resource by devices identified as being within a particular range of such resource. The particular range may be a range in which such devices are able to access and utilize a network resource (e.g., within a particular distance of a Wi-Fi hotspot, a cellular tower, or another wireless access point).

In S309, resource allocation device 109 may reallocate resources on network 1 to intelligently utilize network infrastructure. Specifically, resource allocation device 109 may reallocate network resources from portions of network 1 that the predictive models indicate will be under used (e.g., the region including the neighboring access point described above) to portions of network 1 that the predictive models indicate will be overused (e.g., the region including the particular access point described above). Resource allocation device 109 may control the allocation of network resources in many ways. For example, in the example described above, resource allocation device 109 may limit the number of iPhones with the Hulu app installed thereon that may connect with the particular access point with strained capacity, such that some of the iPhones with the Hulu app installed thereon are forced to connect to the neighboring access point with excess capacity. In other example configurations, resource allocation device 109 may activate additional network nodes that are typically powered off during low utilization periods to conserve energy. In still other example configurations, resource allocation device 109 may repurpose servers 3 to provide particular content or services when the predictive models indicate that such content or services will be in higher demand than the content or services that such servers were previously providing. There are many other possible ways in which resource allocation device 109 may allocate network resources to proactively address potential capacity bottlenecks identified as a result of the collected data and the predictive models. For example, if the predicted amount of utilization of a resource is such that more than about 80% of the capacity of the resource will be utilized, resource allocation device 109 may shift network resources to increase the capacity of the resource.

The intelligent infrastructure capacity management process shown in FIG. 3 is an iterative and ongoing process. Thus, network activity may be constantly monitored (S301) and analyzed (S303) in real-time while predictive models are constantly developed and refined (S305) and applied to the collected data (S307). Thus, network resources may be efficiently allocated and reallocated (S309) in real-time as network conditions change.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method comprising:
receiving first data regarding a first plurality of devices in a network, the first data including:
an amount of utilization of a first plurality of resources in the network by each device of the first plurality of devices; and
characteristic data of each device of the first plurality of devices;
determining a predictive model for utilization of each resource of a second plurality of resources in the network based on the first data;
predicting an amount of utilization of each resource of the second plurality of resources by a second plurality of devices using the predictive model; and
allocating each resource of the second plurality of resources based on the predicted amount of utilization of such resource by the second plurality of devices.

2. The method of claim 1, further comprising:
determining a correlation between the characteristic data of each device of the first plurality of devices and the amount of utilization of each resource of the first plurality of resources,
wherein determining the predictive model for utilization of each resource of the second plurality of resources in the network includes determining the predictive model based on the determined correlation.

3. The method of claim 2, further comprising:
receiving second data regarding the second plurality of devices in a network, the second data including:
characteristic data of each device of the second plurality of devices; and
location data of each device of the second plurality of devices,
wherein the predictive model is configured to output an estimated utilization of a resource of the second plurality of resources by a device of the second plurality of devices in response to receiving as an input the characteristic data of such device and data identifying such resource, and
wherein predicting the amount of utilization of each resource of the second plurality of resources by the second plurality of devices using the predictive model includes, for each resource of the second plurality of resources:
identifying devices of the second plurality of devices that are within a particular range such resource based on the location data of such devices;
inputting the data identifying such resource and the characteristic data of the devices identified as being within the particular range of such resource into the predictive model; and
determining as output from the predictive model a total estimated utilization of such resource by the devices identified as being within the particular range of such resource, the total estimated utilization corresponding to the predicted amount of utilization of such resource.

4. The method of claim 1,
wherein predicting the amount of utilization of each resource of the second plurality of resources by the second plurality of devices using the predictive model includes:
predicting an amount of utilization of a first resource, such that an available capacity of the first resource will be reduced from its current level at a time in the future; and
predicting an amount of utilization of a second resource, such that an available capacity of the second resource will be reduced from its current level at the time in the future, and
wherein allocating each resource of the second plurality of resources based on the predicted amount of utilization of such resource by the second plurality of devices includes repurposing the second resource to perform a function similar to the first resource.

5. The method of claim 1,
wherein predicting the amount of utilization of each resource of the second plurality of resources by the second plurality of devices using the predictive model includes:
predicting an amount of utilization of a first resource, such that an available capacity of the first resource will be reduced from its current level at a time in the future; and
predicting an amount of utilization of a second resource, such that an available capacity of the second resource will be reduced from its current level at the time in the future, and
wherein allocating each resource of the second plurality of resources based on the predicted amount of utilization of such resource by the second plurality of devices includes causing a portion of the second plurality of devices to utilize the second resource instead of the first resource.

6. The method of claim 1,
wherein predicting the amount of utilization of each resource of the second plurality of resources by the second plurality of devices using the predictive model includes:
predicting an amount of utilization of a first resource, such that an available capacity of the first resource will be reduced from its current level at a time in the future; and
predicting an amount of utilization of a second resource, such that an available capacity of the second resource will be reduced from its current level at the time in the future, and
wherein allocating each resource of the second plurality of resources based on the predicted amount of utilization of such resource by the second plurality of devices includes allowing only a particular number of devices of the second plurality of devices to utilize the first resource, such that other devices of the second plurality of devices will utilize the second resource instead of the first resource.

7. The method of claim 1, wherein allocating each resource of the second plurality of resources based on the predicted amount of utilization of such resource by the second plurality of devices includes increasing the capacity of a particular resource in response to determining that the predicted amount of utilization of the particular resource will use more than about 80% of the capacity of the particular resource.

8. A system comprising:
a monitoring device configured to receive first data regarding a first plurality of devices in a network, the first data including:
an amount of utilization of a first plurality of resources in the network by each device of the first plurality of devices; and
characteristic data of each device of the first plurality of devices;
an analysis device configured to:
determine a predictive model for utilization of each resource of a second plurality of resources in the network based on the first data; and
predict an amount of utilization of each resource of the second plurality of resources by a second plurality of devices using the predictive model; and
a resource allocation device configured to allocate each resource of the second plurality of resources based on the predicted amount of utilization of such resource by the second plurality of devices.

9. The system according to claim 8, wherein the analysis device is further configured to:
determine a correlation between the characteristic data of each device of the first plurality of devices and the amount of utilization of each resource of the first plurality of resources, and
determine the predictive model based on the determined correlation.

10. The system according to claim 9,
wherein the monitoring device is further configured to receive second data regarding the second plurality of devices in a network, the second data including:
characteristic data of each device of the second plurality of devices; and
location data of each device of the second plurality of devices,
wherein the predictive model is configured to output an estimated utilization of a resource of the second plurality of resources by a device of the second plurality of devices in response to receiving as an input the characteristic data of such device and data identifying such resource, and
wherein the analysis device is configured to, for each resource of the second plurality of resources:
identify devices of the second plurality of devices that are within a particular range such resource based on the location data of such devices;
input the data identifying such resource and the characteristic data of the devices identified as being within the particular range of such resource into the predictive model; and
determine as output from the predictive model a total estimated utilization of such resource by the devices identified as being within the particular range of such resource, the total estimated utilization corresponding to the predicted amount of utilization of such resource.

11. The system according to claim 8,
wherein the analysis device is configured to:
predict an amount of utilization of a first resource, such that an available capacity of the first resource will be reduced from its current level at a time in the future; and
predict an amount of utilization of a second resource, such that an available capacity of the second resource will be reduced from its current level at the time in the future, and
wherein the resource allocation device is configured to repurpose the second resource to perform a function similar to the first resource.

12. The system according to claim 8,
wherein the analysis device is configured to:
predict an amount of utilization of a first resource, such that an available capacity of the first resource will be reduced from its current level at a time in the future; and
predict an amount of utilization of a second resource, such that an available capacity of the second resource will be reduced from its current level at the time in the future, and
wherein the resource allocation device is configured to cause a portion of the second plurality of devices to utilize the second resource instead of the first resource.

13. The system according to claim 8,
wherein the analysis device is configured to:
predict an amount of utilization of a first resource, such that an available capacity of the first resource will be reduced from its current level at a time in the future; and
predict an amount of utilization of a second resource, such that an available capacity of the second resource will be reduced from its current level at the time in the future, and
wherein the resource allocation device is configured to allow only a particular number of devices of the second plurality of devices to utilize the first resource, such that other devices of the second plurality of devices will utilize the second resource instead of the first resource.

14. A computer program product comprising:
a computer readable storage medium having computer readable program code embodied therewith, the computer readable program code comprising:
computer readable program code configured to receive first data regarding a first plurality of devices in a network, the first data including:
an amount of utilization of a first plurality of resources in the network by each device of the first plurality of devices; and
characteristic data of each device of the first plurality of devices;
computer readable program code configured to determine a predictive model for utilization of each resource of a second plurality of resources in the network based on the first data;
computer readable program code configured to predict an amount of utilization of each resource of the second plurality of resources by a second plurality of devices using the predictive model; and
computer readable program code configured to allocate each resource of the second plurality of resources based on the predicted amount of utilization of such resource by the second plurality of devices.

15. The computer program product of claim 14, further comprising:
computer readable program code configured to determine a correlation between the characteristic data of each device of the first plurality of devices and the amount of utilization of each resource of the first plurality of resources,
wherein the computer readable program code configured to determine the predictive model for utilization of each resource of the second plurality of resources in the network based on the first data includes:
computer readable program code configured to determine the predictive model based on the determined correlation.

16. The computer program product of claim 15, further comprising:
computer readable program code configured to receive second data regarding the second plurality of devices in a network, the second data including:
characteristic data of each device of the second plurality of devices; and
location data of each device of the second plurality of devices,
wherein the predictive model is configured to output an estimated utilization of a resource of the second plurality of resources by a device of the second plurality of devices in response to receiving as an input the characteristic data of such device and data identifying such resource, and
wherein the computer readable program code configured to predict the amount of utilization of each resource of the second plurality of resources by the second plurality of devices using the predictive model includes:
computer readable program code configured to, for each resource of the second plurality of resources, identify devices of the second plurality of devices that are within a particular range such resource based on the location data of such devices;
computer readable program code configured to, for each resource of the second plurality of resources, input the data identifying such resource and the characteristic data of the devices identified as being within the particular range of such resource into the predictive model; and
computer readable program code configured to, for each resource of the second plurality of resources, determine as output from the predictive model a total estimated utilization of such resource by the devices identified as being within the particular range of such resource, the total estimated utilization corresponding to the predicted amount of utilization of such resource.

17. The computer program product of claim 14,
wherein the computer readable program code configured to predict the amount of utilization of each resource of the second plurality of resources by the second plurality of devices using the predictive model includes:
computer readable program code configured to predict an amount of utilization of a first resource, such that an available capacity of the first resource will be reduced from its current level at a time in the future; and
computer readable program code configured to predict an amount of utilization of a second resource, such that an available capacity of the second resource will be reduced from its current level at the time in the future, and
wherein the computer readable program code configured to allocate each resource of the second plurality of resources based on the predicted amount of utilization of such resource by the second plurality of devices includes:
computer readable program code configured to repurpose the second resource to perform a function similar to the first resource.

18. The computer program product of claim 14,
wherein the computer readable program code configured to predict the amount of utilization of each resource of the second plurality of resources by the second plurality of devices using the predictive model includes:
computer readable program code configured to predict an amount of utilization of a first resource, such that an available capacity of the first resource will be reduced from its current level at a time in the future; and
computer readable program code configured to predict an amount of utilization of a second resource, such that an available capacity of the second resource will be reduced from its current level at the time in the future, and
wherein the computer readable program code configured to allocate each resource of the second plurality of resources based on the predicted amount of utilization of such resource by the second plurality of devices includes:
computer readable program code configured to cause a portion of the second plurality of devices to utilize the second resource instead of the first resource.

19. The computer program product of claim 14,
wherein the computer readable program code configured to predict the amount of utilization of each resource of the second plurality of resources by the second plurality of devices using the predictive model includes:
computer readable program code configured to predict an amount of utilization of a first resource, such that an available capacity of the first resource will be reduced from its current level at a time in the future; and
computer readable program code configured to predict an amount of utilization of a second resource, such that an available capacity of the second resource will be reduced from its current level at the time in the future, and
wherein the computer readable program code configured to allocate each resource of the second plurality of resources based on the predicted amount of utilization of such resource by the second plurality of devices includes:
computer readable program code configured to allow only a particular number of devices of the second plurality of devices to utilize the first resource, such that other devices of the second plurality of devices will utilize the second resource instead of the first resource.

20. The computer program product of claim 14, wherein the computer readable program code configured to allocate each resource of the second plurality of resources based on the predicted amount of utilization of such resource by the second plurality of devices includes:
computer readable program code configured to increase the capacity of a particular resource in response to determining that the predicted amount of utilization of the particular resource will use more than about 80% of the capacity of the particular resource.
